(19) United States
(12) Patent Application Publication
(10) Pub. No.: US 2015/0100898 A1
(43) Pub. Date: Apr. 9, 2015

(54) GAMIFIED KNOWLEDGEBASE AND SOCIAL NETWORK APPLICATION

(71) Applicant: JEFFREY JUE, PALOS VERDES ESTATES, CA (US)

(72) Inventor: JEFFREY JUE, PALOS VERDES ESTATES, CA (US)

(21) Appl. No.: 14/510,108

(22) Filed: Oct. 8, 2014

Related U.S. Application Data
(60) Provisional application No. 61/888,004, filed on Oct. 8, 2013.

(51) Int. Cl. H04L 29/08; G06F 3/0484; G06F 17/30; H04L 29/06

(52) U.S. Cl. CPC H04L 67/10; H04L 65/403; G06F 3/0484; G06F 17/30893
USPC 715/753

(57) ABSTRACT

In a knowledgebase system, such as a WIKI, content submissions to the knowledgebase system may be contributed by multiple authors in a collaborative editing environment. In some embodiments of the present invention, author citations are incorporated to demarcate content contributions by author, and to provide corresponding attribution. In other embodiments, a gamification engine and social network are employed to further incentivize content contributions to the knowledgebase system, and to assist with content management and curation.

### FIELD OF THE INVENTION

The present invention relates generally to the field of knowledgebase creation, and more specifically to gamification systems and methods for encouraging, rewarding and attributing contribution of knowledgebase content.

### BACKGROUND OF THE INVENTION

A knowledgebase is an information repository that provides a means for information to be collected, organized, shared, searched and utilized.

One type of knowledgebase is known as a “WIKI,” which is a collaborative web application that allows end users to add and edit content. A WIKI application refers to a collection of WIKI pages written in a markup language that are interconnected via hyperlinks. WIKIs are served by a WIKI server to standard web browsers which function as WIKI clients. A WIKI server can also serve a special web page that is a WIKI editor, where users add and edit content. Some WIKI sites permit WIKI content to be written in accordance with a WIKI syntax, such as having special characters to indicate hyperlinked content, bulleted content, and the like. WIKI syntax is generally designed to be more intuitive for end-users to utilize than standard markup languages.

WIKI applications can be used to quickly generate a large amount of content by allowing a large number of end users to collaboratively contribute and edit content. Today's largest WIKIs (e.g., Wikipedia) have achieved such status by allowing virtually any user to edit virtually any content (Wikipedia even allows virtually anyone to become an editor, and by contributing to the site gain administrator status (granting the power to block and ban users as well as lock and remove pages)).

As a result, while such WIKIs may contain a great deal of information on a wide range of topics, they are ultimately tainted by the fact that the information provided derives from an open group of contributors, resulting in unreliable data lacking proper sources.

Moreover, while such WIKIs can track contribution histories, they do little to both overtly and meticulously attribute individual user contributions. Consequently, readers usually cannot superficially identify the contributor of a particular piece of content in a collaboratively-edited document having multiple authors.

For these and other reasons, existing WIKI tools do not adequately encourage contribution and quality-control of knowledgebase content. What are needed are mechanisms to facilitate encouraging, promoting and attributing contribution of WIKI and other knowledgebase content, preferably in a fashion consistent with general Web 2.0 techniques and protocols.

### SUMMARY OF THE INVENTION

The present invention describes systems and methods for encouraging, promoting and attributing contribution of knowledgebase content. The present invention may have specific applications for a professional WIKI, e.g., one in which content is contributed by professionals seeking to garner business through their contributions.

In contrast to WIKI articles of the prior art, where authorship of content contributed by multiple authors is generally not readily apparent to a reader, WIKI articles according to embodiments of the present invention can not only prominently display such authorship, but can also allow a reader to readily identify corresponding content in the WIKI article attributable to given authors. Specifically, a WIKI article according to one embodiment of the present invention may comprise author class citations and/or footnotes. A WIKI article according to a further embodiment of the present invention may comprise author pop-up profiles, e.g., linked to the author class citations and/or footnotes. A WIKI article according to yet a further embodiment of the present invention may comprise in-text highlighting, e.g., linked to the author class citations and/or footnotes. According to certain further embodiments of the present invention, author class citations and/or footnotes can be manually and/or automatically inserted into the WIKI article, while author pop-up profiles and/or in-text highlighting can be manually and/or automatically linked to the author class citations and/or footnotes. In certain other embodiments of the present invention, author class citation may take the form of a subtle graphic (e.g., in-line with the content, but an image instead of text) that when hovered over is linked to an author pop-up profile and/or in-text highlighting.

While the aforementioned features of the present invention are important to incentivize professionals to contribute content, and thereby building a useful repository of information, other key features of the present invention may be necessary to regulate an online community of professionals. Even if given due credit for their contributions to a WIKI article, professionals may very well be disincentivized from contributing content thereto if they believe that doing so will unduly aid their competitors. For example, if a professional feels that a WIKI is dominated by his competitor (e.g., where the competitor's contributions to the WIKI are overrepresented), that professional may be less likely to contribute useful content to the WIKI where he feels that such a contribution would unduly benefit his competitor (e.g., where attracting additional traffic to the WIKI gives the competitor a relatively high amount of exposure).

Accordingly, in one embodiment of the present invention, a knowledgebase system may comprise a gamification system, wherein a registered user can earn credits for content submission and/or user referral, and wherein a registered user can spend credits to start a premium article in the WIKI and/or improve his or her ranking in an author directory. In a further embodiment of the present invention, the number of credits awarded to a registered user for a user referral is significantly higher than that awarded for content contributions. One possible benefit of these features is that a professional organization (e.g., a law firm) cannot as easily dominate the WIKI by authoring a large number of premium articles (i.e., initial authorship of premium articles is more likely to be distributed amongst registered users from different professional organizations). Specifically, according to certain embodiments of the present invention, if professionals within a professional organization refer each other to join a WIKI, those professionals may not be able to as easily individually accumulate a large number of credits for user referral, given that those professionals often have many shared contacts.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed; the present invention may be employed in not only a WIKI related to the law, but in WIKIs covering other topics (e.g., accounting, medicine, etc.) as well.

### BRIEF DESCRIPTION OF THE DRAWINGS

The invention is better understood from reading the following detailed description of the preferred embodiments, with reference to the accompanying figures in which:

FIG. 1 is a block diagram of a client server environment for knowledgebase systems according to certain embodiments of the present invention;

FIGS. 2 and 3 are diagrams of a WIKI page according to certain embodiments of the present invention, comprising author class citations and footnotes;

FIG. 4 is a process flow of a WIKI editing workflow according to certain embodiments of the present invention, wherein user-submitted edits are stored in a staging mode pending Admin approval and insertion of author citations and footnotes;

FIG. 5 is a process flow of a credit/incentive system according to certain embodiments of the present invention, wherein a registered user can earn credits by successfully referring a contact to the WIKI (e.g., where the registered user is listed as an inviter/referrer by the contact when the contact successfully completes the registration process);

FIG. 6 is a process flow of a credit/incentive system according to certain embodiments of the present invention, wherein a user can opt to spend credits to start a premium article in a WIKI;

FIG. 7 is a process flow of a WIKI editing workflow where the WIKI edit originates from blog content; and

FIG. 8 is a block diagram of an example computing device.

Features, elements, and aspects of the invention that are referenced by the same numerals in different figures represent the same, equivalent, or similar features, elements, or aspects in accordance with one or more embodiments of the system.

### DETAILED DESCRIPTION OF THE EMBODIMENTS

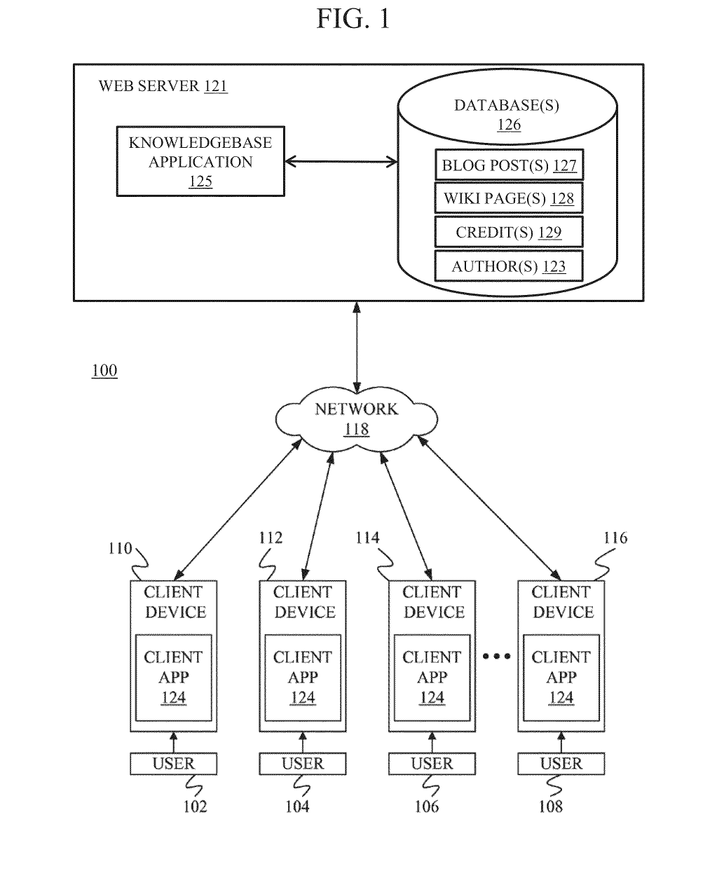

Referring to FIG. 1, knowledgebase environment 100 is but one example of an environment in which embodiments disclosed herein may be implemented. Environment 100 is not intended to suggest any limitation as to scope of use or functionality. Neither should environment 100 be interpreted as having any dependency or requirement relating to any one or combination of illustrated components.

Within environment 100, a plurality of users 102, 104, 106 and 108 are shown as interacting with a plurality of corresponding client computing devices 110, 112, 114 and 116. An illustrative four users and client devices are shown in environment 100 but an actual implementation is just as likely to include more or fewer. Each client computing device interacts across a network 118 with a web server 120. Network 118 can be public in nature (e.g., the Internet, etc.) or more internally focused (e.g., a corporate LAN, a private WAN, etc.).

Web server 120 controls access to and communication with a knowledgebase application 125, which has associated databases 126. Examples of knowledgebase application 125 include, but are not limited to, a WIKI system, gamification system, blog engine and/or social network engine, under some embodiments. Web server 120 may comprise a single computing device or multiple computing devices and portions of knowledgebase application 125 and/or databases 126 may be stored on a single computing device or may be distributed across several computing devices. The illustrated scenario is but an example configuration. Together, knowledgebase application 125 and databases 126 form a knowledgebase system, such as a WIKI or a content management system.

In one embodiment, web server 120 is a computing device responsible for serving web pages (e.g., HTML documents) via the HTTP protocol to client devices 110, 112, 114 and 116. Knowledgebase application 125 generates web pages passed by web server 120 based on content stored for WIKI page(s) 128, and/or associated blog post(s) 127, credit(s) 129 and author(s) 123, in databases 126. Each of devices 110, 112, 114 and 116 includes a client application 124 (e.g., a web browser application) that is able to parse the web pages provided by web server 120 and to display the parsed documents. Client application 124 is also able to collect textual input from the user and to send that input to knowledgebase application 125 through web server 120. In addition, client application 124 is able to interpret certain actions by the user as requests to follow links embedded in the web pages and based on such requests is able to request further pages from client application 124 through web server 120. It should be noted that though the reference numeral 124 has been assigned to represent the client application on all of client devices, in actuality, different client devices could operate different client device applications. The consolidation of the reference numeral is solely for the purpose of simplifying the diagram.

In one embodiment, not by limitation, knowledgebase application 125 is implemented as a server-side script that runs on web server 120, with the content generally stored in database 126, which illustratively includes a relational database management system. In another embodiment, however, a server file system associated with web server 120 can be used for data management also or instead.

Accordingly, in one embodiment, web server 120, knowledgebase application 125 and database 126 together enable each of users 102, 104, 106 and 108 to utilize client applications 124 to read, edit and write their own contributions to one or more WIKI page(s) 128. The users are illustratively able to include links to other pages in the set of WIKI pages 128, blog post(s) 127, credit(s) 129, author(s) 123, external links to the Internet or an Intranet and incorporate other content in the form of text, images, audio, video, etc. The knowledgebase application 125 manages the collaboration processes, including the publication of the WIKI page(s) 128, storage of revision information including the identity of the author(s) 123 who revised content, the date and time the revision was made, and the revisions that were made. The knowledgebase application 125 also includes the ability to call external applications when certain events occur as noted further below.

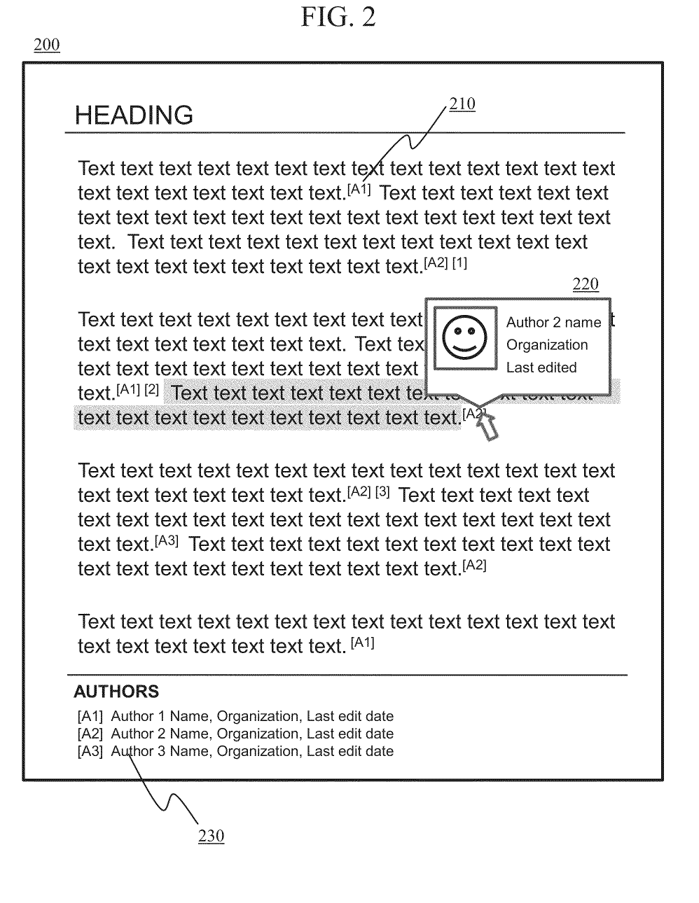

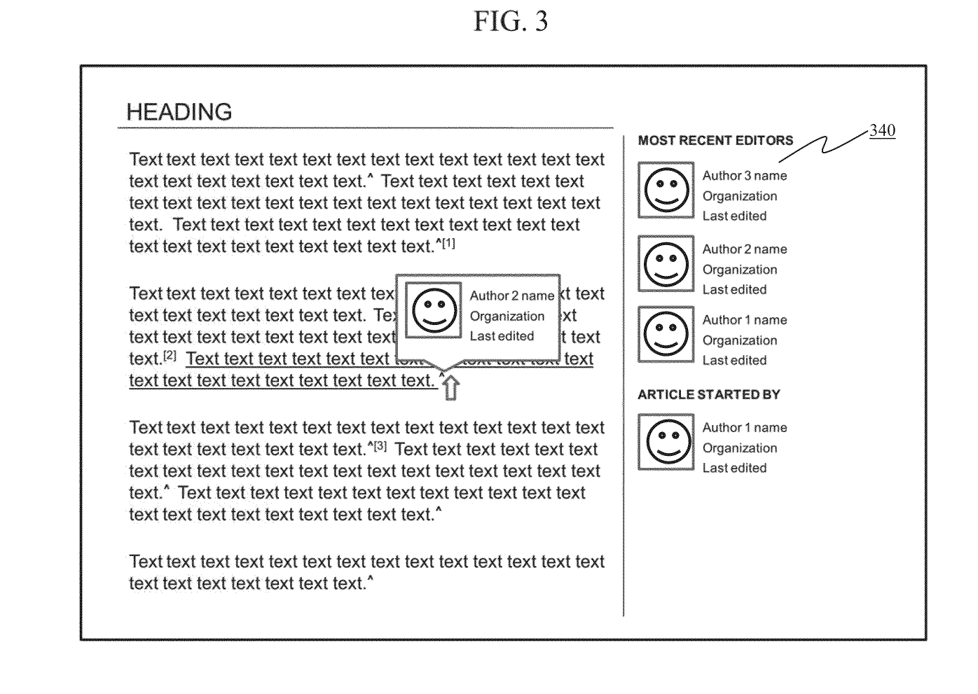

Referring to FIGS. 2 and 3, a WIKI page according to certain embodiments of the present invention may contain an “author class” citation 210. This author class citation indicates the contributor of particular content within the WIKI page, and is distinct from the reference citation of the prior art, the latter indicating the source of a quote or supporting information. In certain embodiments of the present invention, the author class citation may be used in addition to the reference citation of the prior art. The author class citation can allow readers of content to easily and precisely determine the contributor thereof. The author class citation may comprise a text and/or graphic indicator.

In certain further embodiments of the present invention, author class citations can link to author footnotes 230. The author footnotes 230 are preferably limited to one per author, but can additionally or alternatively be included on a one-to-one basis corresponding to each in-text author citation. Author footnotes 230 may be aggregated adjacent to (e.g., below) the content as with traditional footnotes or endnotes (e.g., in order of the authors' respective first contribution dates). In other embodiments of the present invention, author footnotes may be placed in a sidebar 340 adjacent to (e.g., next to, below, etc.) the content, and may take the form of a list of recent authors (e.g., in order of the authors' respective most recent edit dates)—in the latter case, the system may also note the identity of the first or original author of a particular article.

In certain further embodiments of the present invention, author class citations can link to pop-up windows 220, for example those showing author biographical information and/or linking to an author's profile. These pop-up windows 220 can also show information related to the edit history of the corresponding content (e.g., date of edit, last edit date for author, etc.).

In certain further embodiments of the present invention, author class citations can link to a script (e.g., JavaScript, JQuery) that highlights the text content corresponding to the author citation (e.g., a portion of text written by a particular author). For the purpose of this specification, “highlight” and “highlighting” shall be deemed to include underlining or otherwise visually emphasizing a portion of text.

In certain embodiments of the present invention, author class citations are used only to indicate substantive content contributions, e.g., an author class citation would not be awarded for a minor edit (fixing a typo, spelling error, grammar error, syntax, etc.), and the amended content would still be attributed to its original contributor.

In certain embodiments of the present invention, the author citations are only used where there are breaks in authorship, e.g., at the tail end of at least one a text block authored by the registered user and/or at the end of a paragraph. Where a new edit begins within or at the end of a text block authored by the same registered user, any previous author citations that are consequently within the text block can be deleted by the WIKI system. Similarly, if a new edit ends within a text block authored by the same registered user, no new author citation would be inserted (e.g., the WIKI system would incorporate the new edit into the text linked to the previous author citation at the end of the text block).

In certain embodiments of the present invention, the WIKI system and/or Admin may attribute a sentence containing content by multiple authors to just one of the authors (e.g., to the author whose content comprises at least 50% of the sentence).

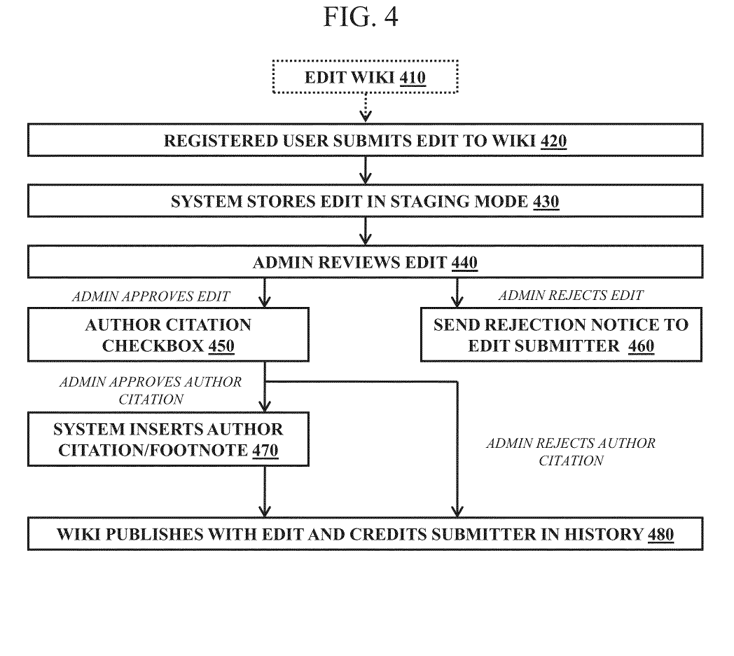

Referring to FIG. 4, in certain embodiments of the present invention, author class citations can be automatically inserted within content by the WIKI system. An author class citation is preferably inserted at substantially every junction between content contributed by different contributors, notwithstanding the substantive content contribution standard described above. Automatic insertion of author class citations may be accomplished in conjunction with a revision history and change-tracking modules. For example, a system may create an XML file with author information for each segment of text in a version of a WIKI article, based on iterative comparisons of versions of the WIKI article stored in the history. The system may update the XML file based on the entire history, or based only on new edits since the last update.

In certain embodiments of the present invention, automatic insertion of author class citations may be facilitated by an Administrator's tagging of user-submitted edits 410 as meriting or not meriting an author citation. For example, referring to FIG. 4, if a registered user submits an edit to a WIKI 420, the system may store the edit in a staging mode 430, e.g., the edit will not publish until and unless an Administrator (Admin) approves the edit. An Admin may review the edit 440 in this staging mode, and make alterations thereto, including insertion of an author citation/footnote 450, 470. Note: an Admin may approve an edit for publication, while deeming that the edit should not get an accompanying author citation (e.g., where an edit fixes a typo, but is not sufficiently substantive to credit a registered user as an author). In certain embodiments, a registered user may be credited in the WIKI history, even if not with an in-text author citation or footnote. Similarly, an Admin may approve an edit for publication 480, even if not with an in-text author citation or footnote. An Admin may signify whether an author citation is proper by toggling a checkbox 450 during the review process (e.g., in the staging mode). In certain embodiments, users may also designate edits as minor or substantive. In certain embodiments, an Admin's rejection of a WIKI edit will cause the WIKI system to send a rejection notification to the user who submitted the edit 460 (e.g., with an explanation for the rejection).

In certain embodiments of the present invention, automatic insertion of author class citations may be accomplished by a script that reads through WIKI content, identifying points in the text where authorship changes according to the aforementioned author citation checkbox used by the Admin to signify whether an author citation is proper. Where the script identifies a change in authorship within the WIKI content, and the corresponding author citation checkbox signifies that an author citation is proper 450, the script can insert an appropriate in-text citation.

In certain embodiments, the author footnotes may be automatically generated during the Admin review process (e.g., in the staging mode). In certain further embodiments, the author footnotes may be automatically generated by referencing the WIKI history, and listing authors chronologically according to when the authors made their first active content contributions. Authors whose content was approved for publication, but was subsequently removed, may likewise be removed from the author footnotes. A script for automatic generation of author citations may replace previous citations, or simply add new ones.

In certain embodiments, the Admin may trigger the automatic insertion of author citations/footnotes during the review process, e.g., once the Admin has completed an initial review of the edit and marked whether an author citation should be included for the edit. The Admin may further review the author citations/footnotes once they have inserted, e.g., prior to approving the edit for publication. In certain embodiments, Admin edits, including but not limited to the insertion of author citations, are not separately recorded in the WIKI history, e.g., the history and author citations may credit a registered user solely with an edit, the edit including any changes made by the Admin during the staging mode (God-mode edits).

In certain embodiments, contributors to the WIKI may be presented with editing guidelines, e.g., encouraging contributors to replace entire sentences and otherwise submit edits in a manner amenable to insertion of practical in-text author citations.

In certain embodiments, authorship of a sentence may be attributed to a user who contributed greater than 50% of the words therein.

In certain embodiments, author citations may be reserved for additions to WIKI content, and may not reflect deletions. In further embodiments, the system may require a user to enter a reason/explanation for a WIKI edit (e.g., when deleting and/or replacing WIKI content).

In certain embodiments, the WIKI may comprise a feedback system, e.g., whereby users can challenge edits or attribution (author citations). A feedback system according to certain embodiments of the invention may also allow users to report other users as unqualified to submit content (e.g., lacking requisite professional credentials), and/or content as inaccurate or lacking objective value (e.g., redundant, merely self-promotion, spam, etc.). Feedback systems may further comprise appeal procedures.

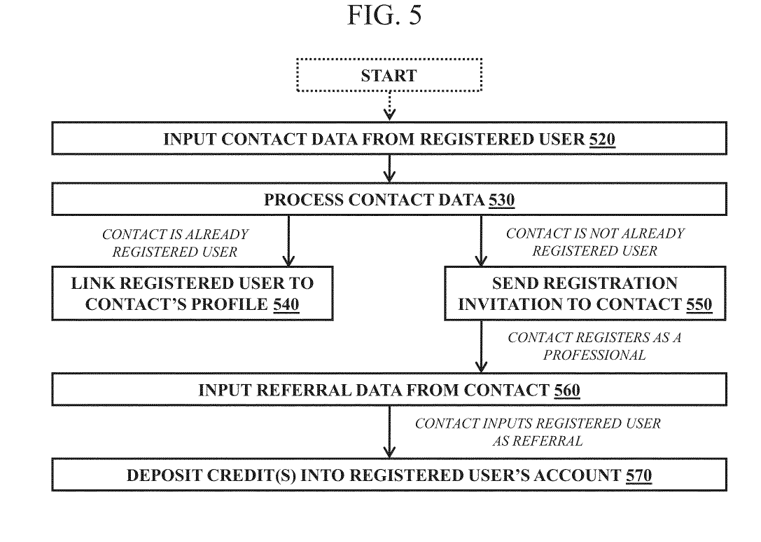

Referring to FIG. 5, a WIKI system according to certain embodiments of the present invention may comprise a gamification system, e.g., in which users are awarded credits or points based on such activities as content (e.g., WIKI edit, blog post, Q&A, comment, etc.) submissions and/or user referrals. For example, a registered user may earn credits for inviting a contact to register with the WIKI, where the contact lists the registered user as an inviter/referrer and successfully completes the registration process. Specifically, in certain embodiments of the present invention the knowledgebase application 125 may contain a social network engine that allows a registered user (inviter) to send invitations by inputting third party (invitee) contact data 520 (e.g., email addresses, social network accounts, etc.), and then processes that contact data 530 (e.g., by determining whether the third party has already registered with the WIKI). Where the third party is already also a registered with the WIKI, the social network engine may link the user accounts of the inviter and invitee (e.g., as professional and/or friend connections) 540. Where the third party has not yet registered with the WIKI, the social network engine may send an invitation to the third party (e.g., by email, or social network messages) to register with the WIKI 550; the social network engine may then identify when the third party accepts the invitation and identify the corresponding inviter 560 such that the inviter will receive gamification credits upon successful registration by the third party with the WIKI 570.

Credits may also be earned for submitting content (e.g., content that gets approved for publication), with credit amounts differing based on the type of content submitted. For example, the knowledgebase may comprise such user-contributed content as news, blogs, Q&A (questions and answers) and forms, in addition to WIKI content.

In certain embodiments of the present invention, the gamification system may award a greater number of points to a user for contribution of content that can be collaboratively edited (e.g., WIKI content) than for contribution of content that cannot be edited by other users (e.g., blog content), as the former is subject to greater scrutiny given that other registered users can remove or revise it.

In certain embodiments of the present invention, the gamification system may award a greater number of credits to a user for contribution of a minor edit to WIKI content than for contribution of substantive content, as the former does not result in in-article attribution but is nonetheless important (e.g., for fixing a typo).

In certain embodiments of the present invention, the gamification system may cap the number of points awarded to a user for editing given content during a given time period (e.g., where a user edits one article on ten occasions in a given week, the user will receive the same number of points as if he or she had only edited that article once in the given week).

In certain embodiments of the present invention, users may be ranked in a directory or leaderboard based on gamification credits. In certain further embodiments of the present invention, users may be ranked in the directory or leaderboard based only on gamification credits earned over a specified period of time preceding the present (e.g., credits earned over the past seven or thirty days).

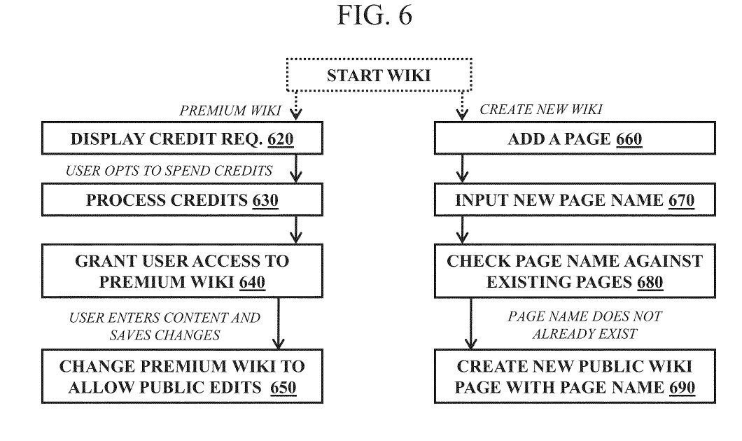

Referring to FIG. 6, gamification credits earned in the aforementioned manner(s) may be used to start a premium article in the WIKI (e.g., a premium WIKI page). A premium article may be one which, for example, covers a very popular topic and/or has relatively high visibility with respect to navigation links. A premium article may be “parked” or reserved, pending a registered user opting to spend credits to start (“unlock”) the article. A premium article may be populated with seed content prior to being unlocked, or may be blank/empty.

For example, the knowledgebase application 125 may present a user seeking to edit a premium article with the credit requirement for doing so 620. If the user has sufficient credits and chooses to spend them unlocking the premium article, the knowledgebase application 125 may process the credits 630 (e.g., deduct the credits from the user's credit balance) and grant the user access to edit the premium article 640. In certain embodiments of the present invention, the user's submission of initial content to the premium article will unlock the premium article for editing by others 650. In certain embodiments of the present invention, WIKI pages other than premium articles may by added without a credit requirement 660, 670, 680, 690. In certain alternate embodiments, starting or editing any WIKI page may by subject to a credit requirement.

In certain embodiments of the present invention, a user's contribution to an unlocked premium will be subject to a character limit (e.g., a user may have to pay credits per hundred characters he or she contributes to or edits within a premium article).

In certain embodiments of the present invention, once a premium article is unlocked by a registered user (e.g., once initial content has been submitted and approved for publication), the premium article may then be edited by other registered users. In certain embodiments, these latter users may edit without having to spend credits. In certain alternate embodiments, these latter users must also spend credits in order to edit a premium article, although in preferred embodiments the credit cost for editing a premium article is less than the credit cost for unlocking a premium article.

In certain embodiments of the present invention, credits may also or alternatively be used to improve placement in a directory of registered users. For example, a registered user may opt to spend credits to temporarily move to a more visible position in a user directory (e.g., “Featured User”) or present a premium profile (e.g., one showing full contact information). In certain embodiments, the general ranking of users in a user directory is based primarily on the number of credits each user has (e.g., total credits, or credits earned within the past week, month, year, etc.). In certain embodiments, a basic user profile contains only one (e.g., “primary”) practice area in which the user will appear in a single practice area directory (e.g., meta data by which users can be searched can include practice area, such that only attorneys in the patent law field will be listed). In certain further embodiments, a premium user profile will allow additional (e.g., “supplementary”) practice areas, such that the user will appear in multiple practice area directories.

In certain embodiments of the present invention, the gamification system may award points on a syndication or back-end basis, wherein a user will receive credits based on the popularity of content that user contributed to. For example, a user may be awarded one credit per month per 10,000 page views received by an article that user contributed to within a given period of time.

In certain embodiments of the present invention, a credit system may also incorporate negative credits, e.g., for reported abuse or removed content.

In certain embodiments of the present invention, other types of content may also be unlocked. For example, the gamification system may require a user to spend credits in order to post an answer to a question, bid on a case, etc. In certain embodiments, only users who have accumulated a threshold amount of credits during a given period of time may make unlock and/or contribute content as described above (e.g., answering questions in the knowledgebase's Q&A).

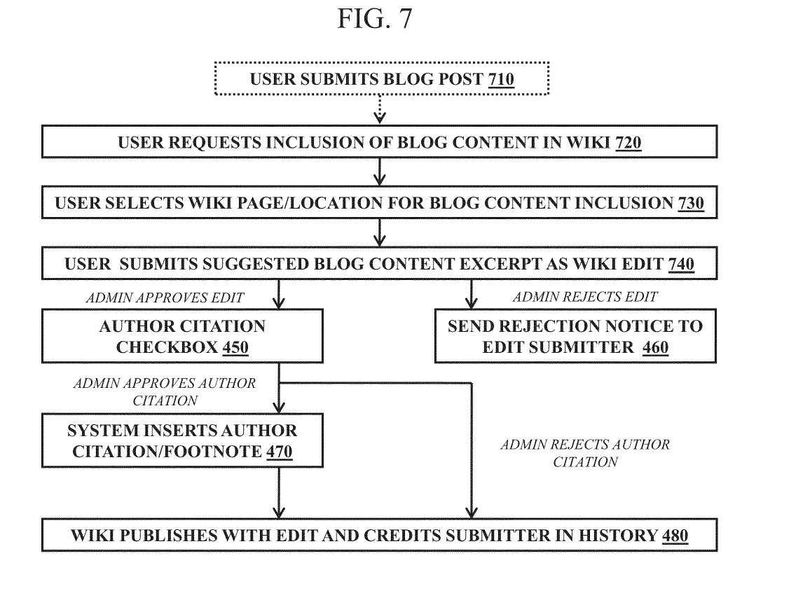

Referring to FIG. 7, a WIKI system according to certain embodiments of the present invention is integrated with user-submitted blog content in the knowledgebase. For example, in certain embodiments a user submitting blog content to the knowledgebase 710 may request inclusion of that blog content in the WIKI 720 (e.g., by marking a checkbox prior to clicking a button to publish the blog post). If the user so requests inclusion of the blog content in the WIKI, the user may select a suggested WIKI page 730 in which the blog content should be included (e.g., through a JavaScript interface that allows search and selection of WIKI page(s) while the aforementioned checkbox is marked); the user may further select a suggested location within the WIKI page (e.g., section, subsection, etc.) wherein the blog content should be included 730. The user may also submit a suggested excerpt from blog content 740 for inclusion in the WIKI page (e.g., the specific sentence of text that should be included in the WIKI page). The user may then submit the request (e.g., but publishing the blog post having marked the checkbox and included the aforementioned WIKI-related information).

In certain embodiments of the present invention, selection of a WIKI page/location 730 and a blog content excerpt 740 may be required to complete the request for inclusion of blog content in the WIKI. In certain embodiments of the present invention, the suggested excerpt may be subject to a word/character limit.

The suggested blog content excerpt may be processed by the WIKI system as a WIKI edit, for example as described above with respect to FIG. 4. In certain embodiments, an author citation and/or pop-up for an approved edit that originates from blog content may display and/or link to the corresponding blog post (e.g., in addition to the author's user profile). In certain embodiments of the present invention, the WIKI page may be curated to a greater extent by Administrators where WIKI edits originate from requests for inclusion of blog content.

In certain embodiments of the present invention, a WIKI edit (e.g., that originate from requests for inclusion of blog content) is subject to credit requirements (e.g., a user making the request must have a minimum amount of gamification credits, and/or if the WIKI edit is approved and published then a certain amount of credits would be deducted from that user's credit balance).

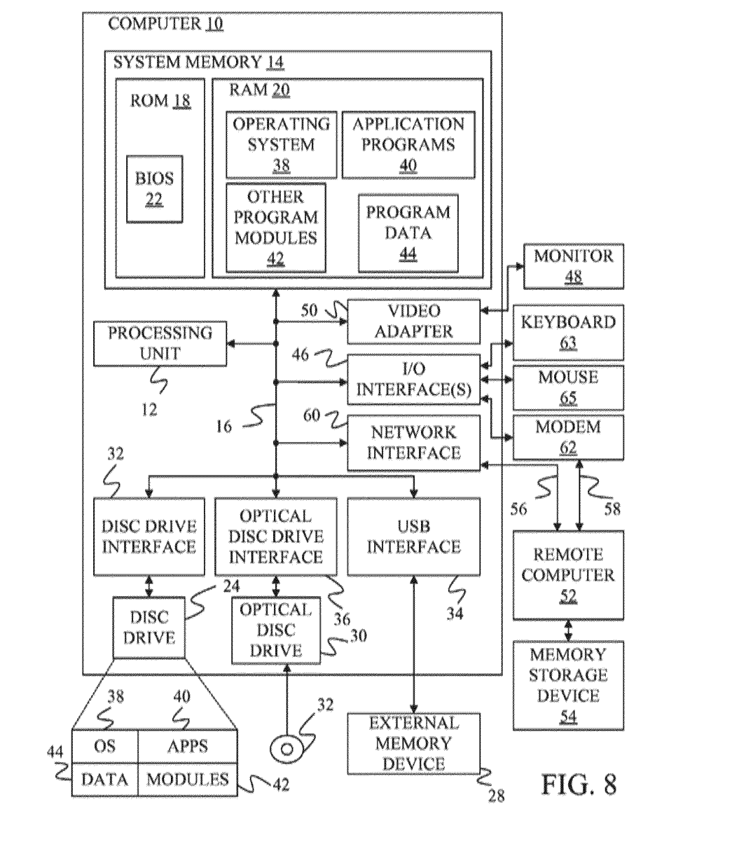

Referring to FIG. 8, the methods and components discussed above may be implemented using computing devices that execute computers executable instructions that are stored or encoded on computer-readable media. For example, web server 120, and client devices 110, 112, 114 and 116 represent computing devices that execute computer-executable instructions representing knowledgebase application 125 and client application 124.

An example of a computing device that can be used as a server or client device is shown in the block diagram of FIG. 8. The computing device 10 of FIG. 8 includes a processing unit 12, a system memory 14 and a system bus 16 that couples the system memory 14 to the processing unit 12. System memory 14 includes read only memory (ROM) 18 and random access memory (ROM) 20. A basic input/output system 22 (BIOS)/containing the basic routines that help to transfer information between elements within the personal computer 10, is stored in ROM 18.

Embodiments of the present invention can be applied in the context of computer systems other than personal computer 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computer 10 further includes a hard disc drive 24, an external memory device 28, and an optical disc drive 30. External memory device 28 can include an external disc drive or solid state memory that may be attached to computer 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage for the personal computer 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include any of the applications, robots or application interfaces discussed above and program data 44 may include data stored in any of the databases or lists discussed above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated.

The personal computer 10 may operate in a network environment utilizing connections to one or more remote computers, such as a remote computer 52. The remote computer 52 may be a server, a router, a peer device, or other common network node. Remote computer 52 may include many or all of the features and elements described in relation to personal computer 10, although only a memory storage device 54 has been illustrated in FIG. 8. The network connections depicted in FIG. 8 include a local area network (LAN) 56 and a wide area network (WAN) 58. Such network environments are commonplace in the art.

The personal computer 10 is connected to the LAN 56 through a network interface 60. The personal computer 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the personal computer 10, or portions thereof, may be stored in the remote memory storage device 54. For example, application programs may be stored utilizing memory storage device 54. In addition, data associated with an application program, such as data stored in the databases or lists described above, may illustratively be stored within memory storage device 54. It will be appreciated that the network connections shown in FIG. 8 are exemplary and other means for establishing a communications link between the computers, such as a wireless interface communications link, may be used.

The present invention has been described above with reference to preferred features and embodiments. Those skilled in the art will recognize, however, that changes and modifications may be made in these preferred embodiments without departing from the scope of the present invention.

What is claimed is:

1. A method of administrating a knowledgebase application using computers connected via a network, the method comprising:
receiving from a registered user an instruction via one of the computers to save an edit to a WIKI page;
determining by executing a computer operation that an author citation is required to demarcate a change in authorship within the WIKI page;
and inserting the author citation in the WIKI page, wherein the author citation identifies the registered user as having contributed the edit.

2. The method of claim 1, further comprising accessing a database to display biographical information for the registered user in connection with the author citation.

3. The method of claim 2, further comprising generating at least one of an author citation footnote and an author citation pop-up linked to the author citation.

4. The method of claim 3, wherein the author citation is located at a tail end of at least one of a text block authored by the registered user and a paragraph.

5. The method of claim 4, further comprising deleting any previous author citation for the registered user located within the text block authored by the registered user within the paragraph.

6. The method of claim 5, further comprising deleting any previous author citation for a different author located within a sentence that is comprised at least 50% by the edit.

7. The method of claim 6, further comprising storing the edit in a staging mode until an administrator approves the edit for publication.

8. The method of claim 7, wherein the registered user is identified only one time in the author citation footnotes in the WIKI page, even where the edit is not the first by the registered user on the WIKI page.

9. The method of claim 8, further comprising confirming that the edit was not designated a minor edit by the registered user or the administrator.

10. The method of claim 9, further comprising highlighting the edit when a reader hovers over the author citation with an input device.

11. A method of administrating a knowledgebase application using computers connected via a network, the method comprising:
receiving from a registered user an instruction via one of the computers to save an edit to a WIKI page;
determining by executing a computer operation whether an author citation is required to demarcate a change in authorship within the WIKI page;
and inserting the author citation in the WIKI page if the computer operation determines the author citation is required, wherein the author citation identifies the registered user as having contributed the edit.

12. The method of claim 11, wherein the author citation is not inserted where the edit is within a text block authored by the registered user within a paragraph.

13. The method of claim 12, further comprising deleting any previous author citation for the registered user located within the text block authored by the registered user within the paragraph.

14. The method of claim 13, further comprising generating at least one of an author citation footnote and an author citation pop-up linked to the author citation.

15. The method of claim 14, further comprising deleting any previous author citation for a different author located within a sentence that is comprised at least 50% by the edit.

16. The method of claim 15, wherein the registered user is identified only one time in the author citation footnotes in the WIKI page, even where the edit is not the first by the registered user on the WIKI page.

17. The method of claim 16, wherein the author citation is not inserted where the edit is designated a minor edit.

18. A non-transitory computer-readable storage medium having computer-executable instructions encoded thereon that when executed on a computer perform steps comprising:
receiving from a registered user an instruction via one of the computers to save an edit to a WIKI page;
determining by executing a computer operation that an author citation is required to demarcate a change in authorship within the WIKI page;
and inserting the author citation in the WIKI page, wherein the author citation identifies the registered user as having contributed the edit.

19. The computer-readable storage medium of claim 18, further comprising generating at least one of an author citation footnote and an author citation pop-up linked to the author citation.

20. The computer-readable storage medium of claim 19, further comprising accessing a database to display biographical information for the registered user in connection with the author citation.
